(19) United States
(12) Patent Application Publication
(10) Pub. No.: US 2014/0232792 A1
(43) Pub. Date: Aug. 21, 2014

(54) FLOW PATH UNIT AND METHOD FOR MANUFACTURING FLOW PATH UNIT

(71) Applicant: Seiko Epson Corporation, Tokyo (JP)

(72) Inventor: Manabu MUNAKATA, Matsumoto (JP)

(73) Assignee: Seiko Epson Corporation, Tokyo (JP)

(21) Appl. No.: 14/179,963

(22) Filed: Feb. 13, 2014

(30) Foreign Application Priority Data
Feb. 18, 2013 (JP) 2013-028781

(51) Int. Cl. B41J 2/14; B41J 2/16

(52) U.S. Cl. CPC B41J 2/14201; B41J 2/1607
USPC 347/68; 29/890.1

(57) ABSTRACT

A flow path unit including a first flow path substrate that includes a plurality of pressure chambers arranged in a row, the plurality of pressure chambers each including a first opening that has, on a substrate surface, a long shape in which a width in a first direction is longer than a width in a second direction that is orthogonal to the first direction. The flow path unit further includes a second flow path substrate joined to the first flow path substrate, the second flow path substrate including a plurality of first flow paths arranged in a row, each first flow path being exposed to the inside of a corresponding first opening in a one-to-one manner. In the flow path unit, a direction in which the pressure chambers are arranged and a direction in which the first flow paths are arranged intersect each other.

### BACKGROUND

1. Technical Field

The present invention relates to a flow path unit and a method for manufacturing the flow path unit.

2. Related Art

A flow path unit that constitutes a liquid ejection head includes pressure chambers that apply pressure to a liquid that has been supplied thereto, flow paths that are in communication with the pressure chambers through which the liquid passes, nozzles that are in communication with the flow paths and that eject the liquid to the outside, and other members (collectively referred to as “various flow paths”). Positioning of a plurality of members that include the various flow paths are carried out, and, in this state, are the plurality of members are stacked and joined such that the above flow path unit is formed.

Furthermore, a method for manufacturing a piezoelectric actuator is known in which a pressure chamber forming plate in which pressure chambers are formed, a vibrating plate that closes the openings of the pressure chambers, and a communication hole forming plate in which communication holes that are in communication with the pressure chambers are formed are stacked, and in which a dispersion liquid that is a piezoelectric material is printed on the vibrating plate at positions corresponding to the pressure chambers with an ink jet recording head such that piezoelectric vibrators are formed on the vibrating plate (see JP-A-2001-187448).

When relative positioning of the plurality of members that constitute the above-described flow path unit is carried out, the various flow paths that are to be in communication with each other need to be positioned so that they are in communication with each other in a precise manner. However, there are cases in which the forming distance between the pressure chambers and the forming distance between the other flow paths of each member do not coincide with each other. In such a case, setting the relative position of the members becomes disadvantageously difficult. In particular, when each member or a portion of each member is formed by firing (sintering) a certain material, there are cases in which the forming distances described above vary due to varying of the shrinkage coefficient of the material when fired. In such cases, it has been difficult to make a flow path unit that has various flow paths that are in communication with each other in a precise manner and that function properly. Furthermore, while JP-A-2001-187448 can relatively arrange the pressure chambers and the piezoelectric elements in a precise manner, improvement of the relative arrangement of the various flow paths remains as an unresolved challenge.

### SUMMARY

An advantage of some aspects of the invention is that a flow path unit in which various flow paths are accurately in communication with each other and a method for manufacturing such a flow path unit are provided.

A flow path unit according to an aspect of the invention includes a first flow path substrate that includes a plurality of pressure chambers arranged in a row, the plurality of pressure chambers each including a first opening that has, on a substrate surface, a long shape (a long-hole shape) in which a width in a first direction is longer than a width in a second direction that is orthogonal to the first direction, and a second flow path substrate joined to the first flow path substrate, the second flow path substrate including a plurality of first flow paths arranged in a row, each first flow path being exposed to the inside of a corresponding first opening in a one-to-one manner. In the flow path unit, a direction in which the pressure chambers are arranged and a direction in which the first flow paths are arranged intersect each other.

According to such a configuration, since the first openings of the pressure chambers have a long hole shape and since the direction in which the pressure chambers are arranged and the direction in which the first flow paths are arranged intersect each other, a state in which the first opening of each pressure chamber and the corresponding first flow path are accurately in communication with each other in a one-to-one manner is achieved.

In the flow path unit according to the aspect of the invention, a distance between the pressure chambers in the direction in which the pressure chambers are arranged and a distance between the first flow paths in the direction in which the first flow paths are arranged may be different.

In other words, even if the distance between the pressure chambers in the direction in which the pressure chambers are arranged and the distance between the first flow paths in the direction in which the first flow paths are arranged are not the same, because the first openings of the pressure chambers have a long hole shape and because the direction in which the pressure chambers are arranged and the direction in which the first flow paths are arranged intersect each other, a state in which the first opening of each pressure chamber and the corresponding first flow path are accurately in communication with each other in a one-to-one manner is achieved.

In the flow path unit according to the aspect of the invention, the second flow path substrate may include a second flow path that supplies a liquid to the pressure chambers and may include the first flow paths downstream of the pressure chamber, and the first flow path substrate may include constriction portions that are each positioned on an upstream side with respect to the corresponding pressure chamber, each constriction portion having a flow path whose cross-sectional area is smaller than a cross-sectional area of the corresponding pressure chamber and may include upstream chambers that are each positioned on an upstream side with respect to the corresponding constriction portion, each upstream chamber having a flow path whose cross-sectional area is larger than the cross-sectional area of the flow path of the corresponding constriction portion. The cross-sectional area of the flow path of each constriction portion may be smaller than a cross-sectional area of the second flow path and may be smaller than an area of a connection region of the corresponding second flow path and upstream chamber.

According to such a configuration, the resistance against the liquid flowing back towards the upstream side from the pressure chamber can be stabilized, and, as a result, the amount of liquid being discharged from the pressure chamber to the first flow path side becomes stable.

In the flow path unit according to the aspect of the invention, a size of the first flow path substrate when projected from a center of projection that is perpendicular to the first flow path substrate may be formed so that the first flow path substrate is included in the second flow path substrate.

According to such a configuration, a state in which portions of the first flow path substrate and portions of the second flow path substrate jutting out and not jutting out from each other due to the intersecting state of the direction in which the pressure chamber is arranged and the direction in which the first flow path is arranged can be eliminated; accordingly, a product with high quality can be provided.

The technical idea according to the invention is not only implemented in the form of a flow path unit but may be embodied in other forms. For example, a liquid ejection head including the flow path unit or, further, an apparatus (liquid ejecting apparatus) mounted with the liquid ejection head may be perceived as an aspect of the invention. Furthermore, a method for manufacturing the above-described flow path unit may be perceived as an aspect of the invention. An exemplary method for manufacturing a flow path unit may be perceived including position adjusting that changes at least one of a first flow path substrate, the first flow path substrate including a plurality of pressure chambers that are arranged in a row, the plurality of pressure chambers each including a first opening that has, on a substrate surface, a long shape in which a width in a first direction is longer than a width in a second direction that is orthogonal to the first direction, and a second flow path substrate including a plurality of first flow paths that are arranged in a row such that a direction in which the pressure chambers are arranged and a direction in which the first flow paths are arranged intersect each other, the position adjusting carried out such that each first flow path is exposed in a one-to-one manner to the inside of a corresponding first opening; and joining that is performed after the position adjusting and that joins a surface of the first flow path substrate on a first opening side and a surface of the second flow path substrate on a side in which the first flow paths are open.

### BRIEF DESCRIPTION OF THE DRAWINGS

The invention will be described with reference to the accompanying drawings, wherein like numbers reference like elements.

FIG. 1 is an exploded perspective view exemplifying a portion of a main configuration of a liquid ejection head.

FIG. 2 is a cross-sectional view illustrating a section passing through a nozzle.

FIG. 3 is a diagram exemplifying a positional relationship between flow paths of a flow path plate and flow paths of a sealing plate and the like.

FIG. 4 is a diagram exemplifying a positional relationship between the flow paths of the flow path plate and the flow paths of the sealing plate and the like and, further, is an exemplification of a position adjustment process.

FIG. 5 is a diagram exemplifying a portion of a first flow path substrate and a portion of a second flow path substrate after the position adjustment process has been carried out.

FIG. 6 a diagram exemplifying outlines of a stacked first flow path substrate and second flow path substrate.

FIG. 7 is a schematic diagram illustrating an exemplary ink jet printer.

### DESCRIPTION OF EXEMPLARY EMBODIMENTS

Hereinafter, exemplary embodiments of the invention will be described with reference to the accompanying drawings.

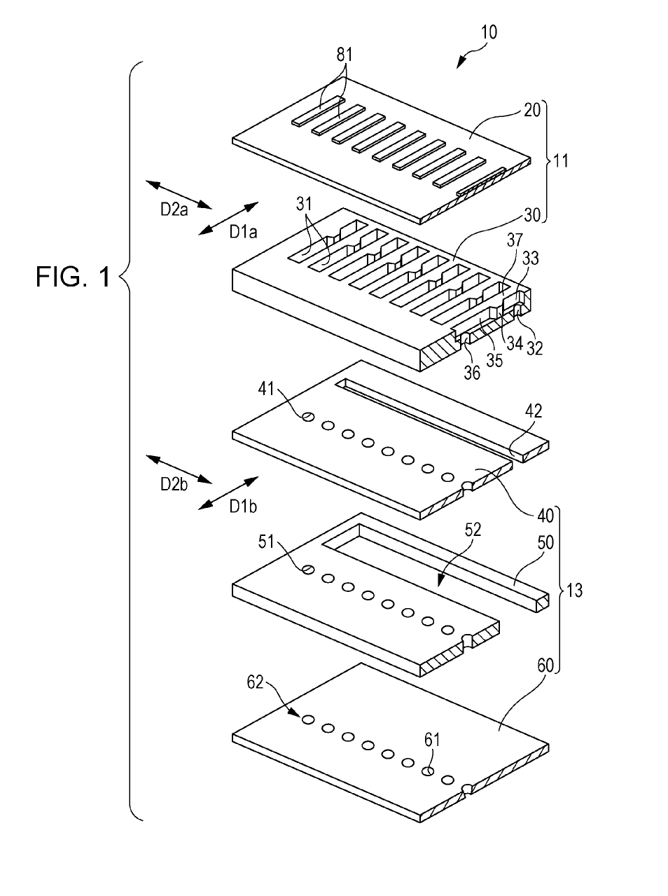

FIG. 1 is an exploded perspective view exemplifying, in a partial manner, a main configuration of a liquid ejection head 10 according to the present exemplary embodiment. The liquid ejection head 10 is configured to include the flow path unit according to the invention. Herein, a description is given of a case in which the liquid ejection head 10 is an ink jet recording head that ejects (discharges) ink. The liquid ejection head 10 includes various components such as a vibrating plate 20, a flow path plate 30, a sealing plate 40, a reservoir plate 50, and a nozzle plate 60. Each of the components may be individually formed and stacked, for example, or some of the components may be integrally formed.

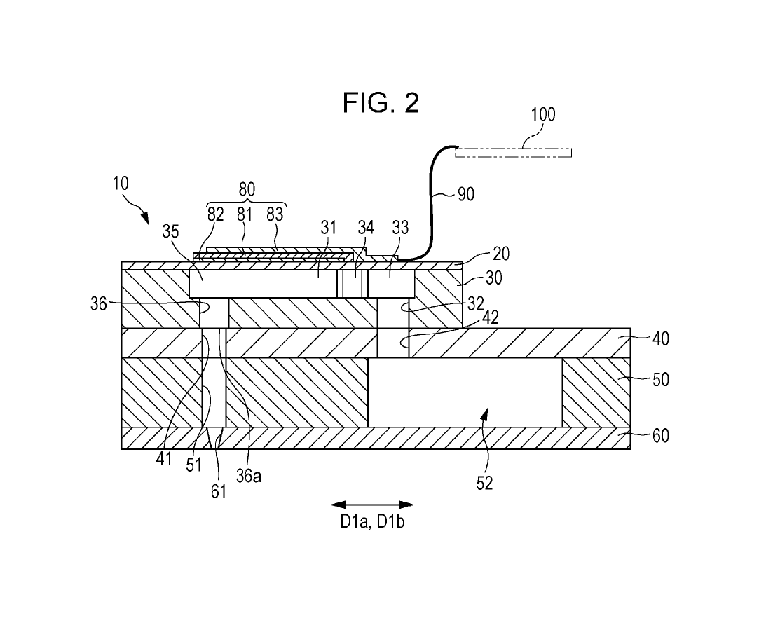

Each of the components, such as the vibrating plate 20, the flow path plate 30, the sealing plate 40, the reservoir plate 50, and the nozzle plate 60 that constitute the liquid ejection head 10 is a substantially rectangular tabular member. First directions are each a direction in which a side of each rectangle extends, and second directions are each a direction that is orthogonal to the corresponding first direction. Furthermore, in the liquid ejection head 10, the first directions related to the components, ideally, run parallel to one another, and the second directions related to the components, ideally, run parallel to one another. FIGS. 1 and 2 exemplify such an ideal state; however, in actuality, there are cases in which the first directions related to the components are not parallel to one another to the extent that an “error” described later is exceeded, and the second directions related to the components are not parallel to one another to the extent that the “error” described later is exceeded.

The vibrating plate 20 seals one side of the flow path plate 30. The vibrating plate 20 and the flow path plate 30 are, for example, formed of a ceramic, a silicon single-crystal substrate, or the like. In the present exemplary embodiment, the vibrating plate 20 and the flow path plate 30 are an integral component made by firing zirconia. Accordingly, the first direction related to the vibrating plate 20 and the first direction related to the flow path plate 30 run parallel to each other, and the second direction related to the vibrating plate 20 and the second direction related to the flow path plate 30 run parallel to each other. Hereinafter, the first direction related to the vibrating plate 20 and the first direction related to the flow path plate 30 will be denoted as a first direction D1a and the second direction related to the vibrating plate 20 and the second direction related to the flow path plate 30 will be denoted as a second direction D2a.

The flow path plate 30 includes a plurality of liquid flow paths 31. The flow paths 31 are arranged in a row in the second direction D2a, which is orthogonal to the first direction D1a, while the longitudinal direction of each flow path 31 is parallel to the first direction D1a. Partition walls 37 are provided between the flow paths 31.

In the present specification, terms such as parallel, orthogonal, same, and other terms used to express the orientation, the position, the distance, and the like of each component of the liquid ejection head 10 not only mean parallel, orthogonal, same, and the like in a strict manner, but also refer to a parallel state, an orthogonal state, a similar state, and other states which include at least an “error” created when the product is manufactured.

Each flow path 31 includes a supply hole 32, an upstream chamber 33, a constriction portion 34, a pressure chamber 35, and a communication hole 36. The upstream chamber 33, the constriction portion 34, and the pressure chamber 35 are open on the one side of the flow path plate 30 described above and are in communication with each other in this order in the longitudinal direction of the flow path 31. The supply hole 32 and the communication hole 36 are open on the other side of the flow path plate 30. The supply hole 32 is in communication with the upstream chamber 33, and the communication hole 36 is in communication with the pressure chamber 35. Piezoelectric elements 80 (see FIG. 2) are mounted on the side of the vibrating plate 20 opposite that facing the flow path plate 30. As will be described later, each piezoelectric element 80 is a pressure generating element including a first electrode, a piezoelectric layer that is in contact with the first electrode on one side, and a second electrode that is in contact with the other side of the piezoelectric layer. FIG. 1 exemplifies piezoelectric layers 81 that constitute the piezoelectric elements 80. Each piezoelectric layer 81 is arranged in correspondence with a pressure chamber 35 of the flow path 31.

The nozzle plate 60 includes a plurality of nozzles serving as through holes for ejecting ink. The communication hole 36 of each flow path 31 is in communication with the corresponding pressure chamber 35 and nozzle 61 in a one-to-one manner. Note that in the example illustrated in FIG. 1, the sealing plate 40 and the reservoir plate 50 are interposed between the other side of the flow path plate 30 described above and the nozzle plate 60. One side of the sealing plate 40 is in contact with the other side of the flow path plate 30 described above. One side of the reservoir plate 50 is in contact with the other side of the sealing plate 40. Furthermore, the other side of the reservoir plate 50 is in contact with the side of the nozzle plate 60 that is opposite to the side (nozzle-opening side) that is exposed to the outside.

The sealing plate 40, the reservoir plate 50, and the nozzle plate 60 may be formed of, for example, a ceramic, a silicon single-crystal substrate, or the like. In the present exemplary embodiment, the sealing plate 40, the reservoir plate 50, and the nozzle plate 60 are formed of stainless steel. Herein, the first directions related to the sealing plate 40, the reservoir plate 50, and the nozzle plate 60 run parallel to each other and the second directions related to the sealing plate 40, the reservoir plate 50, and the nozzle plate 60 run parallel to each other. Hereinafter, each first direction related to the sealing plate 40, the reservoir plate 50, and the nozzle plate 60 is denoted as a first direction D1b, and each second direction related to the sealing plate 40, the reservoir plate 50, and the nozzle plate 60 is denoted as a second direction D2b.

In the example illustrated in FIG. 1, the nozzle plate 60 includes a nozzle row 62 that is a plurality of nozzles 61 formed in the second direction D2b at a predetermined interval (nozzle pitch). Note that the nozzle plate 60 may adopt a structure in which a plurality of nozzle rows, which are each a plurality of nozzles 61 formed in the second direction D2b, are arranged in a row in the first direction D1b, while some nozzle rows and the remaining nozzle rows are arranged so as to be shifted from each other in the second direction D2b (a so-called staggered arrangement).

The reservoir plate 50 includes a plurality of second communication holes 51 and a reservoir 52. The reservoir 52 is also referred to as a common ink chamber. The second communication holes 51 and the reservoir 52 all penetrate the reservoir plate 50. Each second communication hole 51 is arranged at a position corresponding to a position of a nozzle 61 in a one-to-one manner. The length of the reservoir 52 in the second direction D2b is substantially in accordance with the length of the nozzle row 62 in the second direction D2b. The sealing plate 40 includes a plurality of first communication holes 41 and a common supply hole 42. The first communication holes 41 and the common supply hole 42 all penetrate the sealing plate 40.

Similar to the second communication holes 51, each first communication hole 41 is arranged at a position corresponding to a position of a nozzle 61 in a one-to-one manner. Furthermore, each first communication hole 41 is also in communication with the corresponding communication hole 36 in a one-to-one manner. Similar to the reservoir 52, the length of the common supply hole 42 in the second direction D2b is substantially in accordance with the length of the nozzle row 62 in the second direction D2b. Furthermore, the common supply hole 42 is in communication with each supply hole 32. As for the reservoir 52, other than a supply passage of ink supplied from the outside that will be described below, the side that is in contact with the nozzle plate 60 is sealed by the nozzle plate 60 and the side that is in contact with the sealing plate 40, other than the portion that is opposite the common supply hole 42, is sealed by the sealing plate 40.

In the above configuration, at least the flow path plate 30 corresponds to an example of a first flow path substrate according to the claims. Alternatively, the vibrating plate 20 and the flow path plate 30 that are formed integrally may be denoted as the first flow path substrate. Hereinafter, the first flow path substrate will be referred to with a reference numeral “11”. Furthermore, the first flow path substrate 11 on which the piezoelectric elements 80 are mounted may be referred to as an actuator substrate as well. The openings of the communication holes 36 that are on the nozzle 61 side (sealing plate 40 side) and that are in communication with the pressure chambers 35 correspond to an example of a first opening according to the claims.

The sealing plate 40, the reservoir plate 50, and the nozzle plate 60 correspond to an example of a second flow path substrate according to the claims. Hereinafter, the second flow path substrate will be referred to with a reference numeral “13”. The first communication holes 41, the second communication holes 51, and the nozzles 61 of the second flow path substrate 13 that are in communication with the communication holes 36 of the first flow path substrate 11 correspond to an example of a first flow path according to the claims. Furthermore, the reservoir 52 and the common supply hole 42 of the second flow path substrate 13 correspond to an example of a second flow path according to the claims, which supplies a liquid to the pressure chamber 35. Note that the liquid ejection head 10 may not include some of the components illustrated in FIG. 1 or may include components other than the ones illustrated in FIG. 1. For example, the second flow path substrate 13 may not include all of the sealing plate 40, the reservoir plate 50, and the nozzle plate 60 or may include other components (layers) other than the sealing plate 40, the reservoir plate 50, and the nozzle plate 60. Furthermore, each plate is not limited to a plate formed of a single plate (layer) and each of the above-described plates may be a stack of plurality of plates (layers). Furthermore, the above-described plates may be made of a single plate (layer).

FIG. 2 is a section of the liquid ejection head 10 and illustrates a plane that is perpendicular to the second directions D2a and D2b (parallel to the first directions D1a and D1b). The section passes through a nozzle 61. As illustrated in FIG. 2, the pressure chamber 35 is in communication with the nozzle 61 through the communication hole 36, the first communication hole 41, and the second communication hole 51. FIG. 2 also illustrates an opening 36a (first opening) of the communication hole 36, which is in communication with the nozzle 61 side (sealing plate 40 side). Furthermore, piezoelectric elements 80 are joined onto the vibrating plate 20 on the side of the vibrating plate 20 that is opposite to the side that is in contact with the flow path plate 30 at positions that correspond to the positions of the pressure chamber 35. Each piezoelectric element 80 includes a first electrode 82, the piezoelectric layer 81, and a second electrode 83 that are stacked in this order. For example, the first electrode 82 is a common electrode that is commonly provided for the plurality of piezoelectric elements 80, in other words, the first electrode 82 is a common electrode that is shared by the plurality of piezoelectric elements 80. On the other hand, the second electrode 83 is a discrete electrode that is provided for each piezoelectric element 80 and that corresponds to a pressure chamber 35.

A control circuit board 100 is coupled to the second electrode 83 through a pattern-and-cable 90, such as a flexible substrate. A drive voltage is applied from the control circuit board 100. A potential of the first electrode 82 is maintained at a predetermined level, such as a ground level. With the above configuration, the piezoelectric elements 80 are deformed in accordance with the drive voltage. Ink is supplied to the reservoir 52 from the outside through an ink supply passage (not shown). The ink supplied to the reservoir 52 passes through the common supply hole 42 and is supplied to each upstream chamber 33 from the corresponding supply hole 32. The ink in the upstream chamber 33 passes through the constriction portion and is supplied to the pressure chamber 35. The deformation of the piezoelectric element 80 described above bends the vibrating plate 20; accordingly, the pressure inside the pressure chamber 35 is increased and ink inside the pressure chamber 35 is ejected from the nozzle 61 in accordance with the pressure increase. In the flow path ranging from the reservoir 52 to the nozzle 61, the reservoir 52 is on the most upstream side and the nozzle 61 is on the most downstream side.

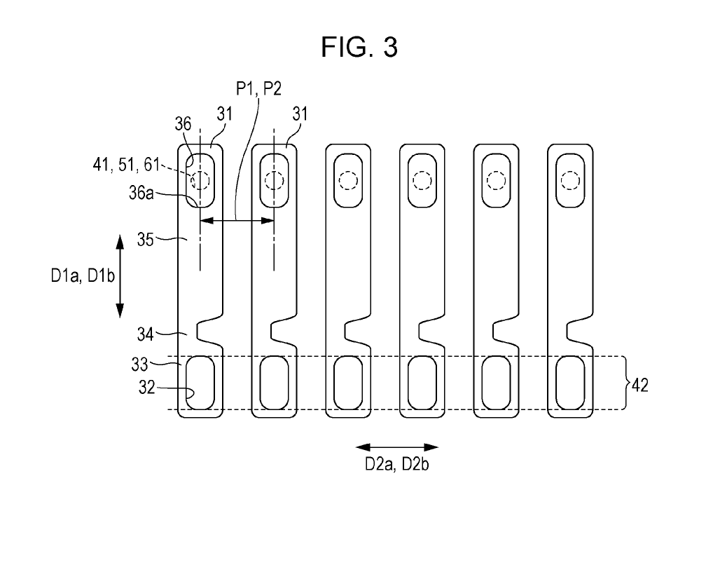

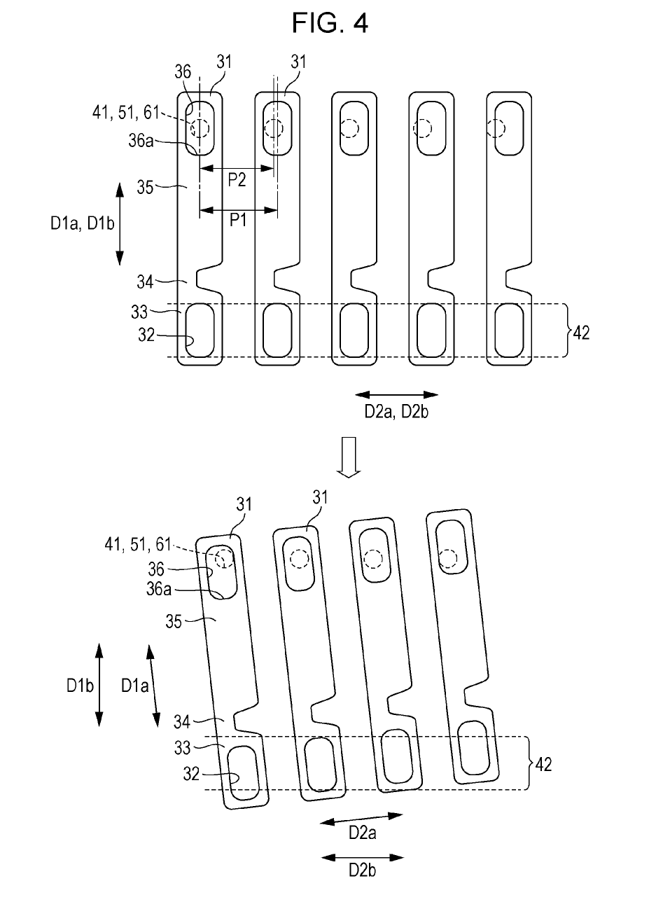

FIG. 3 exemplifies a positional relationship between each flow path 31 formed in the first flow path substrate 11 (the flow path plate 30) and the corresponding first flow path and second flow path formed in the second flow path substrate 13 (mainly the sealing plate 40), when seen from the vibrating plate 20 side. In FIG. 3 as well, the first direction D1a and the first direction D1b run parallel to each other, and the second direction D2a and the second direction D2b run parallel to each other. In FIGS. 3 and 4, each flow path 31 is depicted with a solid line, and each first communication hole 41 (or each second communication hole 51 or each nozzle 61) serving as the first flow path and the common supply hole 42 serving as the second flow path are depicted with a chain line. In FIG. 3, a distance P1 between the flow paths 31 in the second direction D2a related to the first flow path substrate 11, which may also be denoted as the distance between the pressure chambers 35 or the distance between the communication holes 36, for example, and a distance P2 between the first flow paths in the second direction D2b related to the second flow path substrate 13, which may also be denoted as a nozzle pitch, are the same. Accordingly, when the first flow path substrate 11 and the second flow path substrate 13 are stacked such that the direction D1a related to the first flow path substrate 11 and the direction D1b related to the second flow path substrate 13 coincide with each other, then, each first flow path is accurately positioned in accordance with the corresponding communication hole 36 in a one-to-one manner and each first flow path is exposed to the inside of the corresponding opening 36a of the communication hole 36. Furthermore, as shown in FIG. 3, the supply hole 32 of each flow path 31 overlaps the common supply hole 42. In other words, in the example illustrated in FIG. 3, a flow path extending from the reservoir 52 to each nozzle 61 is formed in an ideal manner.

Similar to FIG. 3, a drawing on the upper side of FIG. 4 exemplifies a positional relationship between each flow path 31 formed in the first flow path substrate 11 and the corresponding first flow path and second flow path formed in the second flow path substrate 13. In the example illustrated on the upper side of FIG. 4, the first direction D1a and the first direction D1b are also parallel to each other and the second direction D2a and the second direction D2b are also parallel to each other. However, in the example illustrated in FIG. 4, the distance P1 between the flow paths 31 in the second direction D2a related to the first flow path substrate 11 and the distance P2 between the first flow paths in the second direction D2b related to the second flow path substrate 13 differ (for example, distance P1 being greater than distance P2). Ideally, the distance P1 and the distance P2 are the same. However, in actuality, it is not easy to make the distance P1 and the distance P2 the same. One reason for this is that the distance P1 does not turn out to be an ideal value since the first flow path substrate 11 and the second flow path substrate 13 are formed of different materials and, as described above, when the first flow path substrate 11 is made by firing zirconia, the shrinkage coefficient varies in the material. Accordingly, as illustrated on the upper side of FIG. 4, when the first flow path substrate 11 and the second flow path substrate 13 are stacked by merely matching the first direction D1a and the first direction D1b to each other and the second direction D2a and the second direction D2b to each other, each first flow path and the corresponding communication hole 36 become out of alignment. As a result, there are cases in which a portion of the first flow path is not exposed to the inside of the opening 36a of the communication hole 36.

A feature of the present exemplary embodiment is to provide an appropriate flow path even when, as exemplified on the upper side of FIG. 4, the distance P1 in the second direction D2a related to the first flow path substrate 11, in other words, the distance P1 in the direction in which the pressure chambers 35 are arranged, and the distance P2 in the second direction D2b related to the second flow path substrate 13, in other words, the distance P2 in the direction in which the first flow paths are arranged, are different.

In the present exemplary embodiment, processes including a plate manufacturing process in which each plate is manufactured, a position adjustment process in which the completed plates are stacked and their mutual positions are adjusted, and a joining process in which the plates whose positions have been adjusted are joined together are carried out to manufacture the liquid ejection head 10 including the flow path unit.

A drawing on the lower side of FIG. 4 exemplifies the position adjustment process, seen from a viewpoint similar to that of the drawing on the upper side of FIG. 4, which is one of the processes included in the method for manufacturing the flow path unit including the liquid ejection head 10. In the position adjustment process, the position of at least one of the first flow path substrate 11 and the second flow path substrate 13 is changed so that the second direction D2a and the second direction D2b intersect each other; accordingly, each first flow path is positioned with the corresponding communication hole 36 in a one-to-one manner such that each first flow path is exposed to the inside of the opening 36a of the corresponding communication hole 36. The lower side of FIG. 4 illustrates an example in which the first flow path substrate 11 is turned from the state illustrated on the upper side of FIG. 4 so as to adjust each first flow path to become exposed to the inside of the corresponding communication hole 36.

As can be understood from FIGS. 3 and 4, in the present exemplary embodiment, the openings 36a of the communication holes 36 have a long hole shape in which the width in the first direction D1a is longer than the width in the second direction D2a. Accordingly, as illustrated on the lower side of FIG. 4, even when the relative disposition between the first flow path substrate 11 and the second flow path substrate 13 is changed to some extent, in other words, even when the adjustment described above is carried out, a state in which the opening 36a of the communication hole 36 of each flow path 31 includes therein the opening of the corresponding first flow path can be easily obtained. Note that the degree of freedom regarding the angle in the position adjustment process, in other words, the maximum value of the intersection angle between the second direction D2a and the second direction D2b that allows each nozzle 61 at both ends of the nozzle row 62 to be positioned inside the corresponding opening 36a of the communication hole 36, is mainly dependent on the length of the openings 36a, in other words, the width of the openings 36a in the first direction D1a. In other words, the longer the opening 36a, the larger the intersection angle between the second direction D2a and the second direction D2b, which allows the opening of each first flow path to be positioned inside the corresponding opening 36a, can be; accordingly, even when the distance P1 is not the same as the distance P2 and even when the nozzle rows 62 are long, the first flow path can be made to be in communication with the pressure chambers 35. Furthermore, as can be understood from FIGS. 1, 3, and 4, the common supply hole 42 serving as the second flow path is a long hole that extends in the second direction D2b and that is in communication with the supply holes 32. Accordingly, regardless of whether the distance P1 is the same as the distance P2 and even when the position adjustment process is carried out, a state in which the supply hole 32 of each flow path 31 is in communication with the common supply hole 42 can be easily obtained. However, if the difference between the distance P1 and the distance P2 is excessively large, a communication state cannot be obtained; accordingly, in the plate manufacturing process before the position adjustment process, based on the distance P1 and the distance P2, discrimination is carried out between non-defective products, whose difference between the distance P1 and the distance P2 is not excessively large, and defective products, whose difference is excessively large. Note that compared to a case where the relative disposition between the first flow path substrate 11 and the second flow path substrate 13 is not changed, the present exemplary embodiment can increase the permissible range for determining non-defective products during the discrimination.

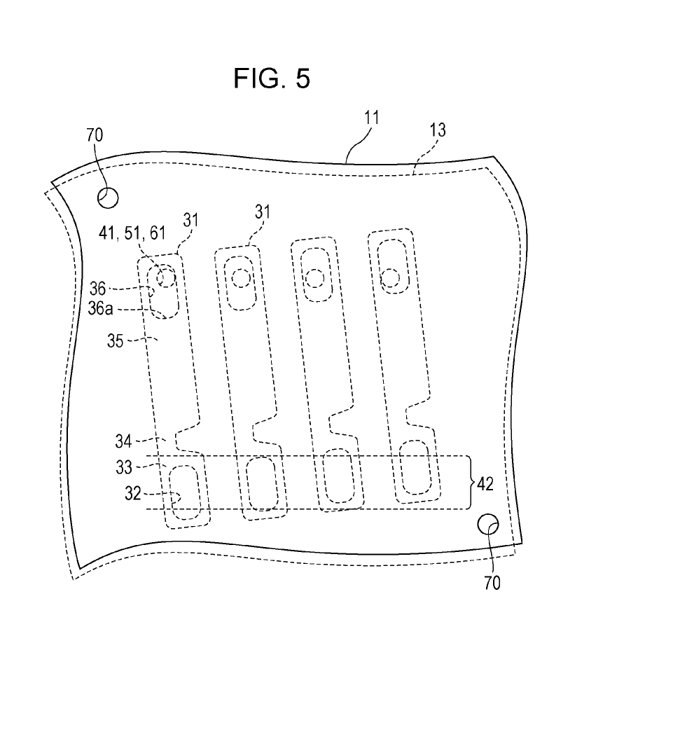

FIG. 5 illustrates, from the side on which the piezoelectric elements 80 of the first flow path substrate 11 are mounted, a portion of the first flow path substrate 11 and a portion of the second flow path substrate 13 after the position adjustment process has been carried out. After the position adjustment process, the joining process that joins the first flow path substrate 11 and the second flow path substrate 13 together is carried out. In the joining process, a position fixing process is first carried out to maintain the positional relationship that has been set in the position adjustment process between the first flow path substrate 11 and the second flow path substrate 13. In the position fixing process, a position fixing hole 70 is formed at two or more positions, for example. The position fixing holes 70 penetrates the first flow path substrate 11 and the second flow path substrate 13, which have gone through the position adjustment process, in the stacking direction thereof. The position fixing holes 70 are formed at positions that do not interfere with the flow paths of the ink. Moreover, by inserting a peg (not shown) into each position fixing hole 70, the positional relationship between the first flow path substrate 11 and the second flow path substrate 13 becomes fixed and the position fixing process is completed. While the positions of the first flow path substrate 11 and the second flow path substrate 13 are fixed in the above manner, heat and pressure are applied to an adhesive which has been coated or adhered between the surface of the first flow path substrate 11 on the opening 36a side and the surface of the second flow path substrate on the first flow path substrate 11 side; accordingly, the first flow path substrate 11 and the second flow path substrate 13 are joined together, in other words, they are bonded by thermocompression. Subsequently, after the adhesive has hardened, the pegs are removed from the position fixing holes 70. Furthermore, the manufacturing of the liquid ejection head 10 is completed by forming the piezoelectric element 80 and connecting the control circuit board 100 thereto.

As described above, according to the present exemplary embodiment, the flow path unit includes the first flow path substrate 11 that includes the plurality of pressure chambers 35 arranged in a row, the plurality of pressure chambers 35 each including an opening 36a that has, on the substrate surface, a long shape in which the width in the first direction D1a is longer than the width in the second direction D2a, which is orthogonal to the first direction D1a. The flow path unit further includes the second flow path substrate 13 that is joined to the first flow path substrate 11. The second flow path substrate 13 includes the plurality of first flow paths (each first flow path including a first communication hole 41, a second communication hole 51, and a nozzle 61) that are arranged in a row, each first flow path being exposed to the inside of the corresponding opening 36a in a one-to-one manner. The direction in which the pressure chambers 35 are arranged and the direction in which the first flow paths are arranged intersect each other. In other words, in the present exemplary embodiment, even if the distance P1 between the pressure chambers 35 in the direction in which the pressure chambers 35 are arranged and the distance P2 between the first flow paths in the direction in which the first flow paths are arranged are not the same, each opening 36a and the corresponding first flow path can be made to accurately be in communication with each other in a one-to-one manner by forming each opening 36a in a long hole shape and by having the direction in which the pressure chambers 35 are arranged and the direction in which the first flow paths are arranged intersect each other.

Furthermore, even if the distance P1 between the pressure chambers 35 in the direction in which the pressure chambers 35 are arranged and the distance P2 between the first flow paths in the direction in which the first flow paths are arranged are not the same, the liquid ejection head 10 is not immediately deemed to be a defective product. The liquid ejection head 10 is not determined as a defective product as long as each first flow path can be adjusted to become exposed to the inside of the corresponding communication hole 36 with the position adjustment process. Accordingly, loss of material and components during manufacture are reduced and the manufacturing cost of the product can be reduced. A description of a case in which the distance P1 is greater than the distance P2 has been mainly given above; however, even if the distance P1 is smaller than the distance P2, each first flow path can be adjusted to become exposed to the inside of the corresponding communication hole 36 by changing the position of at least one of the first flow path substrate 11 and the second flow path substrate 13 such that the second direction D2a and the second direction D2b intersect each other.

Furthermore, as can be understood from FIGS. 3 and 4, a cross-sectional area of the constriction portion 34 of the flow path 31, in other words, area of cross section of the constriction portion 34 that is perpendicular to the first direction D1a, is formed to be smaller than a cross-sectional area of the pressure chamber 35, in other words, area of cross section of the pressure chamber 35 that is perpendicular to the first direction D1a, and a cross-sectional area of the upstream chamber 33, in other words, area of cross section of the upstream chamber 33 that is perpendicular to the first direction D1a. Furthermore, the relevant cross-sectional area of the constriction portion 34, in other words, the cross-sectional area of the constriction portion 34 that is perpendicular to the second direction D2b, is formed smaller than a cross-sectional area of the common supply hole 42, and further is formed smaller than an area of the connection region of the common supply hole 42 and the upstream chamber 33, in other words, an area of the opening of the supply hole 32. In other words, the resistance in the flow path on the upstream side with respect to the constriction portion 34 is made significantly smaller than the resistance in the constriction portion 34 such that the effect exerted by the resistance in the flow path that is on the upstream side with respect to the constriction portion 34 is nullified as much as possible. With such a configuration, the resistance against the ink flowing back towards the upstream side from the pressure chamber 35 can be practically stabilized with the presence of the constriction portion 34; accordingly, the amount of ink being discharged from the pressure chamber 35 to the nozzle 61 side becomes stable in each of the time when the vibrating plate 20 is bent.

### Other Exemplary Embodiments

The invention is not limited to the exemplary embodiment described above and can be implemented in various forms that does not depart from the scope of the invention. The following exemplary embodiments can be implemented, for example. The scope of the disclosure also includes appropriate combinations of the exemplary embodiment described above and one or more of the exemplary embodiments described below.

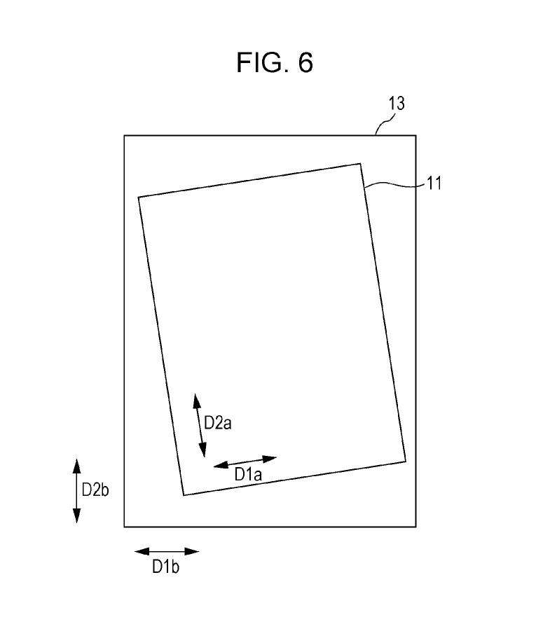

FIG. 6 illustrates outlines of the first flow path substrate 11 and the second flow path substrate 13 that are stacked together viewed from the side in which the piezoelectric elements 80 of the first flow path substrate are mounted. As illustrated in FIG. 6, in the liquid ejection head 10, the outline of the second flow path substrate 13 is larger than the outline of the first flow path substrate 11. Specifically, the size of the first flow path substrate 11, when projected from a center of projection that is perpendicular to the surface of the stacked substrate is formed so that the first flow path substrate 11 is included in the second flow path substrate 13. If the size of the first flow path substrate 11 and that of the second flow path substrate 13 are the same, when either one of the first flow path substrate 11 and the second flow path substrate 13 is turned with respect to the other as described above, the corners of one substrate jut out from the outline of the other substrate and the overall shape becomes distorted.

Accordingly, in this exemplary embodiment, the size of the first flow path substrate 11 and that of the second flow path substrate 13 are set so that even when either one of the first flow path substrate 11 and the second flow path substrate 13 are turned with respect to the other and even when the angle of intersection of the second direction D2a and the second direction D2b becomes its largest, the outline of the one substrate is positioned inside the area defined by the outline of the other substrate. Now, which of the first flow path substrate 11 and the second flow path substrate 13 are to be formed larger depends on, for example, the cost of the material used to form each substrate. As described above, when the first flow path substrate 11 is formed of zirconia and the second flow path substrate 13 is formed of stainless steel, the material of the latter substrate is cheaper; accordingly, the size of the cheaper latter substrate may be formed larger as illustrated in FIG. 6.

The second flow path substrate 13 does not necessarily have to be provided with the sealing plate 40 and the reservoir plate 50. For example, the second flow path substrate 13 may be the nozzle plate 60 alone, may be a stacked body of a so-called compliant plate and a nozzle plate 60, or the nozzle plate 60 and the compliant plate may be joined to the first flow path substrate 11. For example, in a configuration in which the nozzle plate 60 serving as the first flow path substrate 11 is joined to the second flow path substrate 13, a configuration may be adopted in which the flow path plate 30 includes a portion of the reservoir that supplies ink to each pressure chamber 35.

Furthermore, the liquid ejection head 10, serving as a component of an ink jet recording head unit that includes an ink supply passage that is in communication with ink cartridges and the like, is mounted on an ink jet printer 200. The ink jet printer 200 is an example of the liquid ejecting apparatus.

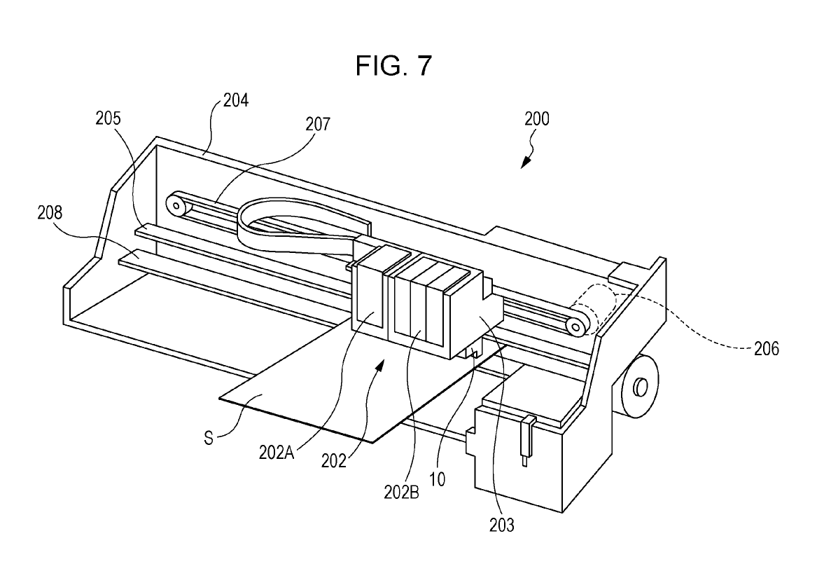

FIG. 7 is a schematic diagram illustrating an example of the ink jet printer 200. In the ink jet printer 200, the ink jet recording head unit (hereinafter referred to as a head unit 202) including a plurality of liquid ejection heads 10 is provided with, for example, ink cartridges 202A, 202B, and the like in a detachable manner. A carriage 203 having the head unit 202 mounted thereto is provided on a carriage shaft 205 that is attached to the apparatus body 204, such that the carriage 203 is capable of moving in the axial direction. Moreover, a driving power of a drive motor 206 that is transmitted to the carriage 203 through a plurality of gears (not shown) and a timing belt 207 moves the carriage 203 along the carriage shaft 205.

An apparatus body 204 is provided with a platen 208 that extends along the carriage shaft 205, and a printing medium S that is fed by a roller and the like (not shown) is transported over the platen 208. Furthermore, ink is ejected from the nozzles 61 of the liquid ejection heads 10 onto the printing medium S that is transported and an arbitrary image is printed on the printing medium S. Note that the ink jet printer 200 is not limited to a printer in which the head unit 202 moves in the manner described above but may be, for example, a so-called line head printer in which the liquid ejection heads 10 are fixed and printing is carried out by merely moving the printing medium S.

Furthermore, the invention may be applied to liquid ejection heads and liquid ejecting apparatuses that eject liquid other than ink. For example, the liquid ejection head may include a color material ejection head that is used to manufacture color filters for liquid crystal displays and the like, an electrode material ejection head that is used to form electrodes for organic EL displays and field emission displays (FED), a bio organic matter ejecting head used to manufacture biochips. The invention may be applied to liquid ejecting apparatuses that are mounted with these liquid ejection heads.

The entire disclosure of Japanese Patent Application No. 2013-028781, filed Feb. 18, 2013 is incorporated by reference herein.

What is claimed is:

1. A flow path unit, comprising:
a first flow path substrate that includes a plurality of pressure chambers arranged in a row, the plurality of pressure chambers each including a first opening that has, on a substrate surface, a long shape in which a width in a first direction is longer than a width in a second direction that is orthogonal to the first direction; and
a second flow path substrate joined to the first flow path substrate, the second flow path substrate including a plurality of first flow paths arranged in a row, each first flow path being exposed to an inside of the first opening,
wherein a direction in which the pressure chambers are arranged and a direction in which the first flow paths are arranged intersect each other.

2. The flow path unit according to claim 1, wherein
a distance between the pressure chambers in the direction in which the pressure chambers are arranged and a distance between the first flow paths in the direction in which the first flow paths are arranged are different.

3. The flow path unit according to claim 1, wherein
the second flow path substrate includes
a second flow path that supplies a liquid to the pressure chambers and
the first flow paths downstream of the pressure chamber,
the first flow path substrate includes
constriction portions that are each positioned on an upstream side with respect to the corresponding pressure chamber, each constriction portion having a flow path whose cross-sectional area is smaller than a cross-sectional area of the corresponding pressure chamber and
upstream chambers that are each positioned on an upstream side with respect to the corresponding constriction portion, each upstream chamber having a flow path whose cross-sectional area is larger than the cross-sectional area of the flow path of the corresponding constriction portion, and
the cross-sectional area of the flow path of each constriction portion is smaller than a cross-sectional area of the second flow path and is smaller than an area of a connection region of the corresponding second flow path and upstream chamber.

4. The flow path unit according to claim 1, wherein
a size of the first flow path substrate when projected from a center of projection that is perpendicular to the first flow path substrate is formed so that the first flow path substrate is included in the second flow path substrate.

5. A method for manufacturing a flow path unit, comprising:
position adjusting that changes at least one of a first flow path substrate, the first flow path substrate including a plurality of pressure chambers that are arranged in a row, the plurality of pressure chambers each including a first opening that has, on a substrate surface, a long shape in which a width in a first direction is longer than a width in a second direction that is orthogonal to the first direction, and a second flow path substrate including a plurality of first flow paths that are arranged in a row such that a direction in which the pressure chambers are arranged and a direction in which the first flow paths are arranged intersect each other, the position adjusting carried out such that each first flow path is exposed in a one-to-one manner to an inside of a corresponding first opening; and
joining that is performed after the position adjusting and that joins a surface of the first flow path substrate on a first opening side and a surface of the second flow path substrate on a side in which the first flow paths are open.
